(19) United States
(12) Patent Application Publication
(10) Pub. No.: US 2025/0165469 A1
(43) Pub. Date: May 22, 2025

(54) Machine Learning Models as a Differentiable Search Index for Directly Predicting Resource Retrieval Results

(71) Applicant: Google LLC, Mountain View, CA (US)

(72) Inventors: Yi Tay, Singapore (SG); Vinh Quoc Tran, New York, NY (US); William Weston Cohen, Pittsburgh, PA (US); Donald Arthur Metzler, JR., Sunnyvale, CA (US)

(21) Appl. No.: 18/837,122

(22) PCT Filed: Feb. 9, 2023
(86) PCT No.: PCT/US2023/012691

§ 371 Date: Aug. 8, 2024

Related U.S. Application Data
(60) Provisional application No. 63/308,210, filed on Feb. 9, 2022.

(51) Int. Cl. G06F 16/2453

(52) U.S. Cl. CPC G06F 16/24542

(57) ABSTRACT

Provided are systems and methods for training and/or use of a machine learning model that can directly predict one or more resources that are responsive to a query as an output of the model. In particular, the present disclosure demonstrates that information retrieval can be accomplished with a single machine learning model (e.g., that has a neural network architecture such as, for example, a Transformer architecture) in which all information about the corpus is encoded in the parameters of the model. To this end, the present disclosure introduces the Differentiable Search Index (DSI), a new paradigm that learns a query-to-result (e.g., in text-to-text format) model that will map queries (e.g., text strings) directly to relevant resource identifiers (“docids”) (e.g., text and/or number strings that identify relevant resources); in other words, a DSI model answers queries directly using only its parameters, dramatically simplifying retrieval

### RELATED APPLICATIONS

This application claims priority to and the benefit of U.S. Provisional Patent Application No. 63/308,210, filed Feb. 9, 2022. U.S. Provisional Patent Application No. 63/308,210 is hereby incorporated by reference in its entirety.

### FIELD

The present disclosure relates generally to systems and methods for the retrieval of resources (e.g., from a defined set of resources) that are responsive to a query. More particularly, the present disclosure relates to systems and methods for training and/or use of a machine learning model that can directly predict one or more resources that are responsive to a query as an output of the model.

### BACKGROUND

Information retrieval (IR) systems typical map a user query q to a ranked list of relevant resources d₁; . . . ; dₙ, typically represented by integers or short strings called resource identifiers (which can be referred to as “docids”). The most widely used approaches to IR are based on static similarity measures (e.g., TFIDF or BM25) or, more recently, dual encoder (DE) systems.

### SUMMARY

Aspects and advantages of embodiments of the present disclosure will be set forth in part in the following description, or can be learned from the description, or can be learned through practice of the embodiments.

One example aspect is directed to a computer-implemented method to perform resource retrieval with improved computational efficiency. The method includes obtaining, by a computing system comprising one or more computing devices, a query. The method includes processing, by the computing system, the query with a machine-learned resource retrieval model to generate a model prediction from the machine-learned resource retrieval model. The model prediction directly predicts one or more resources that are predicted to be responsive to the query from a resource corpus containing a plurality of resources. A plurality of resource identifiers are respectively associated with the plurality of resources. The model prediction comprises the resource identifiers for the one or more resources that are predicted to be responsive to the query. The method includes providing, by the computing system, the model prediction as an output.

Another example aspect is directed to a computing system for training a model to perform resource retrieval with improved computational efficiency, the computing system comprising one or more processors and one or more non-transitory computer-readable media that collectively store instructions that, when executed by the one or more processors, cause the computing system to perform operations. The operations include obtaining, by the computing system, a resource corpus comprising a plurality of resources, wherein a respective resource identifier is associated with each of the plurality of resources. The operations include, for each of one or more input resources of the plurality of resources: processing, by the computing system, data descriptive of the input resource with a resource retrieval model to generate a predicted resource identifier for the input resource; evaluating an indexing loss function that compares the predicted resource identifier to the actual resource identifier for the input resource; and modifying one or more parameters of the resource retrieval model based on the indexing loss function.

Another example aspect is directed to a computer-implemented index structure embodied on a non-transitory medium. The computer-implemented index structure used for searching a resource in a database. The computer-implemented data structure comprising a machine-learned resource retrieval model configured to process a query to generate a model prediction from the machine-learned resource retrieval model, wherein the model prediction directly predicts one or more resources that are predicted to be responsive to the query from a resource corpus containing a plurality of resources, wherein a plurality of resource identifiers are respectively associated with the plurality of resources, wherein the model prediction comprises the resource identifiers for the one or more resources that are predicted to be responsive to the query, and wherein the model prediction causes operation of a device to retrieve the one or more resources that are predicted to be responsive to the query from the database.

Another example aspect is directed to a database management system implemented on one or more computers to perform retrieval of data from a data structure. The database management system comprising an index implemented as a machine-learned resource retrieval model. The machine-learned resource retrieval model configured to process a query to generate a model prediction from the machine-learned resource retrieval model, wherein the model prediction directly predicts one or more resources that are predicted to be responsive to the query from a resource corpus containing a plurality of resources, wherein a plurality of resource identifiers are respectively associated with the plurality of resources, wherein the model prediction comprises the resource identifiers for the one or more resources that are predicted to be responsive to the query, and wherein the model prediction causes operation of a device to retrieve the one or more resources that are predicted to be responsive to the query from the database.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts an example approach to train a machine learning model on an indexing task according to example embodiments of the present disclosure.

FIG. 1B depicts an example approach to train a machine learning model on a retrieval task according to example embodiments of the present disclosure.

FIG. 2 depicts an example approach to use a machine learning model to perform a retrieval task according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to training and/or use of a machine learning model that can directly predict one or more resources that are responsive to an index token or a query as an output of the model. Aspects of the present disclosure pertain to database management. In alternative database management systems, index and/or retrieval operations are conventionally done by, for example, table lookups and the like. Aspects of the present disclosure replace such alternative means of accessing information in a database with a machine learning model. In particular, the present disclosure demonstrates that information retrieval can be accomplished with a single machine learning model (e.g., that has a neural network architecture such as, for example, a Transformer architecture) in which all information about the resources is encoded in the parameters of the model. To this end, the present disclosure introduces the Differentiable Search Index (DSI), a new paradigm that learns a query-to-result (e.g., in text-to-text format) model that will map queries (e.g., text strings) directly to relevant resource identifiers (“docids”) (e.g., text and/or number strings that identify relevant resources); in other words, a DSI model answers queries directly using only its parameters, dramatically simplifying retrieval. Additional aspects of the present disclosure study variations in how resources and docids are represented, variations in training procedures, and the interplay between model size and size of the resource set. Example experiments contained in the U.S. Provisional Patent Application No. 63/308,210 demonstrate that given appropriate design choices, an example DSI can dramatically outperform strong baselines such as dual encoder models. Moreover, DSI demonstrates strong generalization capabilities, outperforming BM25 baselines in a zero-shot setup. However, it will be appreciated that many benefits, as outlined herein, arise from the replacement of conventional database technology with a machine learning model and that these benefits accrue independent of the detailed implementation or benchmark performance.

More particularly, in contrast to existing approaches such as conventional database indexing technology, static similarity measures, or dual encoders, the present disclosure proposes an alternative architecture, in which a machine learning model (e.g., a sequence-to-sequence learning system) is used to directly map a query q to a relevant docid dⱼ. In particular, a query can be or include any input that can be used to retrieve resources (e.g., from a defined set of resources) One example use is to retrieve one or more documents from a corpus (or database) of documents. In one example, the query can be a text string such as a question and/or web search query. Alternatively or additionally, the query can include imagery (e.g., still images or multiple image frames for example from a video), audio data, and/or other modalities of data (e.g., which can be represented as a sequence of data inputs). A resource can include any dataset that is retrieved in response to a query. For example, a resource can include a web resource (e.g., website), a book or article, a pre-defined textual response, a word processing resource, a spreadsheet resource, an image, a video, a data file, a row or other entry in a spreadsheet or a database, a user account, and/or other sets of data (e.g., that can be represented using a docid). A collection of resources (e.g., having a defined membership) can be referred to as a corpus or database. A query can also comprise index tokens to implement index-based database access.

In some instances, the proposed architecture can be referred to as a differentiable search index (DSI). In some examples, the DSI can be implemented with a large pre-trained Transformer (Vaswani et al., 2017) model, building on the recent success of large generative language models (LMs). The Transformer model can include an encoder and a decoder. In addition to Transformers, other sequence-to-sequence models can be used alternatively or additionally. One benefit of use of a Transformer model is that it enables parallelization. Another example sequence-to-sequence model is the long short term memory network. Use of a sequence-to-sequence model can have a number of benefits, including, as examples, the ability to receive queries as an input sequence. This can enable queries to be provided as structured docids, natural language queries, etc. Use of a sequence-to-sequence model can also enable outputs to be provided as an output sequence. The can provide benefits such as enabling beam search to be performed over a set of structured docids that have prefix(es) that enable hierarchical document retrieval.

At inference time, the trained model can receive as an input a query q (e.g., as text, imagery, and/or audio) and output a docid dⱼ. If desired, beam search can be used to produce a ranked list of potentially-relevant docids. One example task used to demonstrate the disclosed systems is to retrieve supporting passages given questions from the Natural Questions (NQ) dataset, a task that is difficult to do using lexical models. Another example task is an indexing task in which an index of resources is to be built from a set of resources, where the index enables retrieval of any one or more of the resources from the set of resources.

This process can work surprisingly well when trained properly. In example experiments it can consistently outperform DE baselines, sometimes dramatically: for a base-sized T5 model, Hits@1 on the smallest corpus is improved by more than 20 points, from 12.4% for a DE to 33.9% for DSI; and on a corpus 30× larger, performance is improved by nearly 7 points. These gains increase when larger models are used: for an 11B-parameter T5 model, Hits@1 performance improves by more than 25 points over DE on the small corpus, and more than 15 points on the large corpus. DSI also performs extremely well in a zero-shot setting, e.g., improving Hits@1 by 14 points over BM25. The T5 model is described at Raffel et al., Exploring the Limits of Transfer Learning with a Unified Text-to-Text Transformer, (2020). The Hits@N metric is an information retrieval metric and can include determining how many positive/correct resources are returned in the top n positions.

In addition to these quantitative gains, the DSI architecture is much simpler than a Dual Encoder (DE) approach or conventional database access methods. A DE system fixes a search procedure (e.g., MIPS) and learns internal representations that optimize performance for that search procedure. In contrast, a DSI system contains no special-purpose fixed search procedure, instead using standard model inference to map from encodings to docids.

Furthermore, in DSI all aspects of retrieval are mapped into well-understood ML tasks. This may lead to new potential approaches to solving long-standing IR problems: as one example, since indexing is now a special case of model training, incrementally updating an index becomes a special case of model updating. For example, adding new resources to the corpus and model can be as simple as retraining the model on the new resources as a batch of training data. As can be seen, the disclosed methods provide a index data structure in the form of the network structure and learned parameter values that provides an efficient and well understood method for updating the index by updating (incrementally learning) the parameters of the network, as opposed to re-building the index as in conventional database management technology.

There are a number of ways to implement the DSI techniques. Various different iterations are explored further herein.

Resource representation. There are several ways in which resources can be represented. One example is a “naive” approach of using the resource's full text, as well as variants of the bag-of-words representation used by traditional IR engines.

Docid representation. There are several ways in which docids can be represented. In one example, integers can be represented as text strings. In another example, the docids can be unstructured docids, where each resource is assigned a unique token. In other examples, baselines are provided for constructing semantically structured docids that describe how to navigate to a resource through a hierarchical clustering of the corpus. Structured docids-either semantically structured via clustering, or naively structured as tokenized integers-scale better to large corpora, since the size of the vocabulary used in the decoder is made larger.

Indexing. A trainable IR system traditionally has two phases: indexing a corpus (i.e., memorizing information about each resource), and learning how to effectively retrieve from the index. In DSI, the index is stored in the model parameters, and indexing is simply another kind of model training. One example approach to indexing a corpus is to train on (1) examples (x; y) that pair a resource x=dj with its docid y=j, in addition to (2) examples (x; y) that pair a query x=q with a relevant docid y=j. In this setup the examples of type (1) are “indexing” examples while the examples of type (2) are “retrieval” examples.

The present disclosure demonstrates that even naive representations for resources and docids, coupled with appropriate training procedures to fine-tune modern large LMs, can perform surprisingly well. Multiple improved docid representations are provided, including unstructured docids and semantically-structured docids, which improve the naive representation choice. It is also shown that there is wide variation in performance among indexing/training strategies; and that performance of DSI systems improves consistently and significantly with model scale. The provided techniques are the first case of generative indexing improving performance over strong baselines for a well-studied resource retrieval task.

The systems and methods of the present disclosure provide a number of technical effects and benefits. As one example, the systems and methods described herein provide improved indexing and information retrieval such as, for example, improved ability to retrieve relevant resources from a corpus responsive to a query. For example, example results contained in the U.S. Provisional Patent Application No. 63/308,210 demonstrate that given appropriate design choices, an example DSI can dramatically outperform strong baselines such as dual encoder models on various information retrieval tasks. Thus, the systems and methods of the present disclosure improve the functioning of a computer itself in its ability to retrieve information that is responsive to a query.

As another example technical effect and benefit, the systems and methods described herein enable the conservation of computer resources such as processor usage, memory usage, etc. For example, dual encoder systems require the generation and storage of a significant number of fixed representations for resources in a corpus. Storage of these representations requires memory usage. In contrast, the present disclosure contains all information about the resources within the model parameters. Therefore, a large table of resource representations does not need to be stored.

More particularly, the proposed techniques operate to compress an index of resources into the parameter values of a resource retrieval model. In particular, rather than store a separate index of resources (e.g., as a table or otherwise), in the present disclosure all information about the resources is directly encoded into the parameters of the model. Thus, for typical index and model sizes, a model trained according to the proposed techniques represents a compression of the index into a reduced data volume, thereby conserving memory resources. Similarly, the trained model also represents an executable version of a search index. Thus, rather than being a static index that is the subject of additional retrieval operations, the trained model is executable to directly predict resource results for a query, this approach reduces the overall number of processing operations that need to be performed, thereby conserving computational resources such as processor usage.

The reduction in memory requirements as described above may also enable the information retrieval process to be performed in resource-constrained environments such as performance “on-device” where the device is a user device such as a smartphone and/or on embedded systems or edge nodes in a network. Furthermore, because the index of resources is encoded into the model itself, the model can be adaptively scaled (e.g., via model distillation techniques) to meet certain parameter size and/or latency constraints. For example, a first resource retrieval model having a first parameter size or latency can be trained. The first resource retrieval model can be distilled to a second resource retrieval model having a second, smaller parameter size or second, smaller latency. The second resource retrieval model can be deployed in a resource-constrained environment to facilitate resource retrieval within the resource-constrained environment (e.g., “on-device”). As one example, a resource retrieval model (e.g., a distilled model as described above) can be shipped or included as part of a mobile application (e.g., that performs on-device retrieval such as on-device content searching).

Furthermore, updating of existing dual encoder-based systems to account for new resources can be a laborious process in which, in some instances, the entire table of representations for all resources needs to be updated. In contrast, the models described herein can be updated to accommodate new resources simply by re-training the model on the new resources. Therefore, the overall number of processing operations can be reduced, thereby conserving computer resources such as processor cycles, etc. Finally, providing an improved ability to perform information retrieval can also result in savings of computational resources. For example, by providing improved results in response to an initial search, subsequent queries can be avoided, thereby reducing the number of queries performed overall and conserving computational resources. Additionally, by combining query parsing, indexing, and retrieval (tasks which were heretofore performed separately) into as single feedforward operation in the machine learning model, computational resources can be preserved.

With reference now to the Figures, example embodiments of the present disclosure will be discussed in further detail.

### Example Model Training

One concept behind the proposed Differentiable Search Index (DSI) is to fully parameterize traditionally multi-stage retrieve-then-rank pipelines within a single neural model. To do so, DSI models can support one or more of the following modes of operation:

Indexing: a DSI model can learn to associate the content of each document dⱼ with its corresponding docid j. The present disclosure provides a straightforward sequence-to-sequence (seq2seq) approach that takes document tokens as input and generates identifiers as output.

Retrieval: Given an input query, a DSI model can learn to return a ranked list of candidate docids. In some implementations of the present disclosure, this can be achieved with autoregressive generation.

Thus, in some implementations, a DSI model can be trained to index a corpus of documents and then optionally fine-tuned on an available set of labeled data (e.g., queries and labeled documents), and thereafter used to retrieve relevant documents-all within a single, unified model. As opposed to retrieve-then-rank approaches, this type of model allows for simple end-to-end training and can easily be used as a differentiable sub-component of a larger, more complex neural model.

Various indexing strategies can be used to learn associations between documents and their identifiers. Some example implementations train a DSI model to predict docids given a sequence of document tokens. This allows the model to learn which identifier belongs to which document and can be thought of as a differentiable take on traditional search indexes. Various alternatives are possible as well.

One example approach may be referred to as Inputs2Target. This approach can be viewed as seq2seq task of doc_tokens→docid. As its name suggests, this binds the docids to the document tokens in a straightforward inputs-to-targets fashion. The advantage here is that the identifier is the denoising target, which puts it in closer proximity to the loss function. Since the retrieval task is also concerned with predicting identifiers, this formulation allows the network to follow a similar input-target balance in terms of sequence length. A potential weakness is that the document tokens are not denoising targets and therefore there is no opportunity for general pre-training on document tokens.

Another example approach may be referred to as Targets2Inputs. This formulation considers the opposite of the above, i.e., generating document tokens from identifiers, i.e., docid→doc_tokens. Intuitively, this is similar to training an autoregressive language model that is conditioned on the docid.

Another example approach may be referred to as a Bidirectional approach. This formulation trains both Inputs2Targets and Targets2Inputs within the same co-training setup. A prefix token can be prepended to allow the model to know which direction the task is being performed in.

Some or all of these approaches may also include or be combined with performance of span corruption. Span corruption-based denoising can be performed with the inclusion of docid tokens. In this approach, the identifier can be concatenated to the document tokens as a prefix. Spans of the concatenated data can be randomly corrupted. The model can then be tasked with predicted the masked spans. This method has the advantage of (1) also performing general pre-training during indexing and (2) achieving a good balance of docids as denoising targets and inputs.

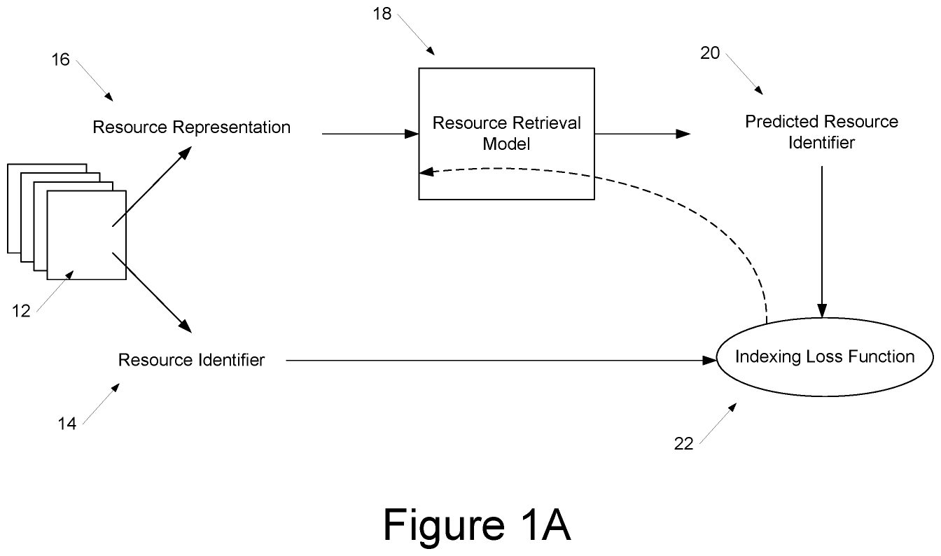

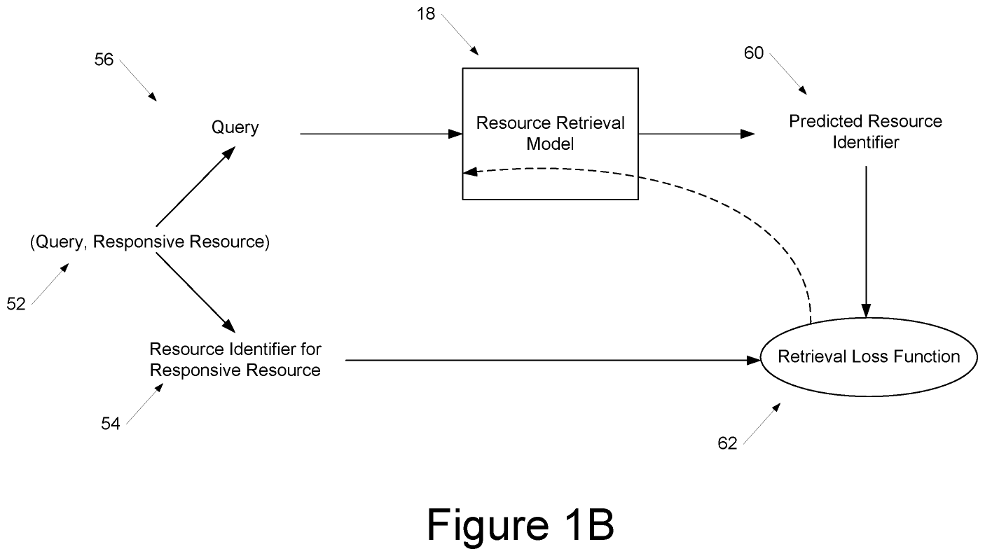

Some or all of the approaches above can be performed to train a DSI model to perform an indexing task. As an example, FIG. 1A depicts an example approach to train a machine learning model on an indexing task according to example embodiments of the present disclosure. As illustrated in FIG. 1A, a computing system can obtain a resource corpus or database comprising a plurality of resources. As examples, a resource can include a web resource (e.g., website), a book or article, a pre-defined textual response, a word processing resource, a spreadsheet resource, an image, a video, a row or other entry in a spreadsheet or a database, a data file, a user account, and/or other sets of data. A plurality of resource identifiers can be respectively generated for associated with the plurality of resources.

The training process shown in FIG. 1A can occur for each resource in the plurality of resources. For example, a resource 12 is shown as having a resource identifier 14 and a resource representation 16. Example approaches for generating the resource representation 16 for the resource 12 are described further elsewhere herein.

There are a number of ways to generate the resource identifier 14 for the resource 12. As examples, the respective resource identifier associated with each resource in the plurality of resources can include an unstructured atomic identifier, an unstructured string identifier, or a structured semantic identifier.

An unstructured atomic identifier can include an arbitrary and/or random unique integer identifier. More particularly, one way to represent documents is assign each an arbitrary (and possibly random) unique integer identifier. These can be referred to as unstructured atomic identifiers. With these identifiers, one potential decoding formulation is to learn a probability distribution over the identifiers. In this case, models can be trained to emit one logit for each unique docid (|N_{documents}|). This is analogous to the output layer in standard language models, but extended to include docids.

To accommodate this, the output vocabulary of a standard language model can be extended as follows:

$$O = Softmax ( {[ {W}_{t o k ens} ; {W}_{docs} ]}^{T} {h}_{last} )$$

where [;] is the row-wise concatenation operator, Wₜₒₖₑₙₛ∈ [symbol] ^{d}^{_{model}}^{×|N}^{ₜₒₖₑₙₛ}^{|} and W_{docs}∈ [symbol] ^{d}^{_{model}}^{×|N}^{_{documents}}^{|} hₗₐₛₜ is the last layer's hidden state (∈ [symbol] ^{d}^{_{model}}) of the decoder stack. To retrieve the top-k documents for a given query, the output logits can be sorted and the corresponding indices can be returned.

An unstructured string identifier can include arbitrary and/or random unique integers that are represented as tokenizable strings. In this formulation, retrieval can be accomplished by decoding a docid string sequentially one token at a time. This eliminates the need for the large softmax output space that comes with unstructured atomic identifiers. It also eliminates the need to learn embeddings for each individual docid. When decoding, beam search can be used to obtain the predicted best docid. With this strategy, it is less straightforward to obtain a top-k ranking. One could exhaustively comb through the entire docid space and obtain the likelihood of each docid given the query. Instead, a partial beam search tree can be used to construct top-k retrieval scores. This approximation is quite efficient and effective in practice.

As another example, the respective resource identifier associated with each resource in the plurality of resources can include a structured semantic identifier. For example, the respective structured semantic identifier associated with each resource in the plurality of resources can be generated via iterative clustering of a plurality of embeddings respectively associated with the plurality of resources. For example, the embeddings can be generated by a pre-trained language model. An embedding for a resource can be a representation of the resource in a lower-dimensional space than the resource space and therefore can represent a compressed version of the resource. For example, iterative clustering can include generate a first set of clusters and then, independently within each generated cluster generating an additional seat of clusters, and so on.

More particularly, some example implementations of the present disclosure aim to automatically create identifiers that satisfy the following properties: (1) the docid should capture some information about the semantics of its associated document, (2) the docid should be structured in a way that the search space is effectively reduced after each decoding step. This results in identifiers where semantically similar documents share identifier prefixes.

As one example approach, to construct identifiers with this property, a computing system can perform a hierarchical clustering process over document embeddings to induce a decimal tree (or more generally, a trie).

Specifically, as one example approach, given a corpus to be indexed, all documents are clustered into a number (e.g., 10) of clusters. Each document is assigned an identifier with the number of their cluster. For every cluster containing more than c documents, the algorithm is applied recursively, with the next level's result (the remaining suffix of the identifier) appended to the existing identifier.

Example Algorithm for Generating Semantically
Structured Identifiers:

```
Input: Document embeddings X_{1:N}, where Xᵢ ∈ [symbol]   ^{d}
Output: Corresponding docid strings J_{1:N}
function GenerateSemanticIDs(X_{1:N})
  C_{1:10} ← Cluster(X_{1:N}, k = 10)
  J ← emptylist
  for i = 0 to 9 do
    J_{current} ← [i] * |Cᵢ₊₁|
    if |Cᵢ₊₁| > c then
      Jᵣₑₛₜ ←GenerateSemanticIDs(Cᵢ₊₁)
    else
      Jᵣₑₛₜ ← [0, ... , |Cᵢ₊₁| − 1]
    end if
    J_{cluster} ←elementwiseStrConcat(J_{current}, Jᵣₑₛₜ)
    J ← J.appendElements(J_{cluster})
  end for
  J ← reorderToOriginal(J, X_{1:N}, C_{1:10})
  return J
end function
```

For clusters with c documents or less, each element can be assigned an arbitrary number from 0 to at most c−1 and likewise its digits can be appended to the existing identifier. Although this example process induces a decimal tree, it is possible to induce similar types of tries using any number of other reasonable strategies. For example, some implementations can simply apply k-means over embeddings generated by a small 8-layer BERT model, with c=100.

Referring still to FIG. 1A, there are a number of ways to generate the resource representation 16 for the resource 12. For example, the resource representation 16 can include direct indexing tokens extracted from the input resource 12; set indexing tokens extracted from the input resource 12; inverted indexing tokens extracted from the input resource 12; and/or other representations. For example, generating direct indexing tokens can include taking the first K tokens from the resource. This strategy preserves sequential order and directly and exactly represents the resource.

Generating set indexing tokens can include applying set processing to the resource and removing duplicate tokens. This strategy does not maintain exact order of the token sequence. For example, documents may contain repeated terms and/or non-informative words (e.g., stopwords). Example implementations of this strategy can de-duplicate repeated terms using the default Python set operation and remove stopwords from the document. The rest of the document after filtering can be passed into the model in similar fashion to the direct index.

Generating inverted indexing tokens can include mapping terms (e.g., tokens) instead of entire resources directly to the resource identifier. For example, the computer system can randomly subsample K tokens and associate them with the resource identifier. A hyperparameter Nₛₐₘₚₗₑ can also be defined that considers how many times to sample from each resource. Note that this strategy can also result in a set index. For example, example implementations of this strategy can map chunked documents (e.g., contiguous blocks of tokens) instead of entire documents directly to the docid. A single contiguous chunk of k tokens can be subsampled and then associated with the docid. One advantage of this approach is to allow looking beyond the first k tokens.

The computing system can process the resource representation 16 with a resource retrieval model to generate a predicted resource identifier 20 for the input resource 12. The computing system can evaluate an indexing loss function 22 that compares the predicted resource identifier 20 to the actual resource identifier 14 for the input resource 12. Thus, the indexing loss function 22 can evaluate an ability of the machine-learned resource retrieval model to output the resource identifier associated with a particular resource when provided with data descriptive of the particular resource as an input (e.g., the resource representation described above). In some implementations, the resource retrieval model can be sequence-to-sequence model such as, for example, a Transformer model or other self-attention-based model.

The computing system can modify one or more parameters of the resource retrieval model 18 based on the indexing loss function 22. For example, as shown visually with the dashed line, the indexing loss function 22 can be backpropagated through the resource retrieval model 18 to update the parameters of the model 18.

FIG. 1B depicts an example approach to train the resource retrieval model 18 on a retrieval task according to example embodiments of the present disclosure. In FIG. 1B, the computing system has access to a number of query/resource tuples where each query/resource tuple includes a query and one or more resources that have been labeled as responsive to the query. In FIG. 1B, a single query/resource tuple 52 is shown as including a query 56 and a resource identifier 54 for a resource that has been labelled as responsive to the query 56.

In some implementations, the query/resource tuple 52 can be collected or taken from real-world queries and responses that were returned (e.g., by an existing search engine) in response to the query. For example, a user can submit a query to a search engine or other information retrieval service. The information retrieval service can return a number of candidate resources (e.g., documents, URLs, etc.) that are potentially responsive to the query. The user can select one of the resources (e.g., by clicking on the result). In response, the query and the resource selected by the user can be logged as a query/resource tuple 52, and then used to train the model 18 as described in FIG. 1B.

In other implementations, the query/resource tuple 52 can be synthetically generated. For example, a resource may be accessed. The resource can be processed with a pre-trained or pre-existing model or algorithm for document summarization, query generation, or other similar tasks. For example, a query generation model can be trained to generate a query when given a resource. For example, the query generation model can be trained using real-world query/resource tuples as described in the paragraph immediately above. Specifically, the query generation model can be provided with the resource and tasked with predicting the corresponding query included in the tuple. A loss function can compare the predicted query with the real query and used to update the query generation model. Once the query generation model has been trained as described above, it can generate synthetic queries for resources that do not yet have a corresponding query associated therewith. For example, an additional resource can be processed with the query generation model to generate a synthetic query. The synthetic query and the resource can be logged as an additional query/resource tuple 52, and then used to train the model 18 as described in FIG. 1B.

In FIG. 1B, the computing system can process the query 56 with the resource retrieval model 18 to generate a predicted resource identifier 60. A retrieval loss function 62 can compare the predicted resource identifier 60 with the resource identifier 54 for the responsive resource. Thus, the retrieval loss function 62 can evaluate an ability of the resource retrieval model 18 to output the resource identifier associated with a particular resource when provided with a training query for which the particular resource has been labeled as a response.

In some implementations, the resource retrieval model 18 can be trained using only the indexing loss approach shown in FIG. 1A. In some implementations, the resource retrieval model 18 can be trained using only the retrieval loss approach shown in FIG. 1B. In some implementations, the resource retrieval model 18 can be trained using the indexing loss approach shown in FIG. 1A first, and then subsequently trained using the retrieval loss approach shown in FIG. 1B. In some implementations, the resource retrieval model 18 can be trained using the indexing loss function of FIG. 1A and the retrieval loss function of FIG. 1B in a multi-task training approach (e.g., where training on the two approaches is interleaved or performed in an alternating fashion). In some implementations, a hyperparameter can control a mixing of the indexing loss function of FIG. 1A and the retrieval loss function of FIG. 1B during the multi-task training approach. In some implementations, the hyperparameter can change in value over time so that, initially, the indexing loss function of FIG. 1A is emphasized while, in later stages, the retrieval loss function of FIG. 1B is increased or emphasized.

Thus, some example DSI models can be optimized for seq2seq cross entropy loss and can be trained with teacher forcing. One example training strategy is to first train a model to perform indexing (memorization), followed by a fine-tuning stage where the trained model is used to map queries to docids (e.g., retrieval). A second example strategy is to train the two tasks together in a multi-task setup. To this end, the different co-training tasks can be differentiated using task prompts.

### Example Model Inference

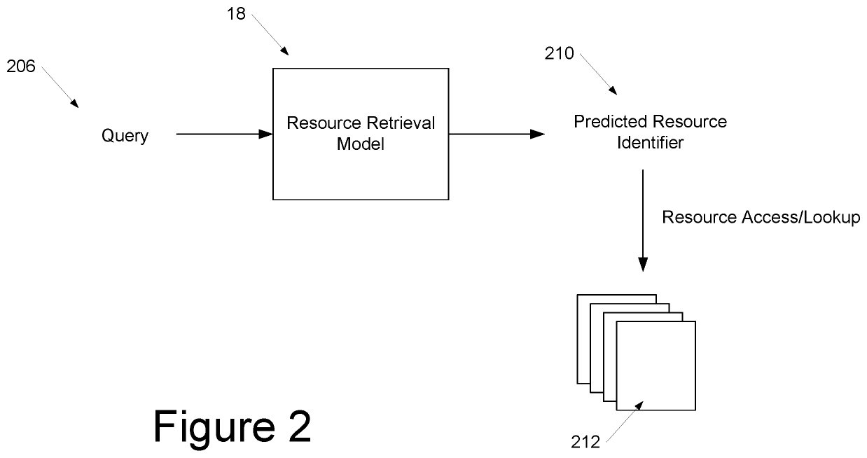

FIG. 2 depicts an example approach to use the resource retrieval model 18 to perform a retrieval task according to example embodiments of the present disclosure. In FIG. 2, a computing system can obtain a query 206. The query 206 can be or include any input that can be used to retrieve resources from a corpus. In one example, the query 206 can be a text string such as a question and/or web search query. Alternatively or additionally, the query 206 can include imagery, audio data, and/or other modalities of data (e.g., which can be represented as a sequence of data inputs).

The computing system can process the query 206 with the machine-learned resource retrieval model 18 to generate a model prediction from the machine-learned resource retrieval model. In some implementations, the machine-learned resource retrieval model can be sequence-to-sequence model such as, for example, a Transformer model or other self-attention-based model. In particular, the model prediction can directly predict one or more resources that are predicted to be responsive to the query 206 from a resource corpus 212 containing a plurality of resources.

As one example, the model prediction from the model 18 can be or include a predicted resource identifier for the resource predicted to be responsive to the query 206. The computing system can use the predicted resource identifier 210 to retrieve, access, and/or lookup the identified resource from the corpus 212. For example, the retrieved resource can be provided to a user or other processing system.

In some implementations, the machine-learned resource retrieval model 18 can be or include a sequence-to-sequence model that receives and processes the query 206 as an input sequence to generate one or more predicted output sequences as the model prediction. For example, the one or more one or more predicted output sequences can be the predicted resource identifier 210. As examples, the model 18 can be a neural network such as, for example, a self-attention based network such as a Transformer or the like. In examples in which the query is multi-modal, a multi-modal model such as a Vision Transformer can be used.

As described above, the respective resource identifier associated with each resource in the plurality of resources comprises an unstructured atomic identifier; an unstructured string identifier; and/or a structured semantic identifier.

In some implementations, the model prediction from the machine-learned resource retrieval model 18 can be or include a softmax output over the plurality of resources in the corpus 212 (e.g., a softmax output over the plurality of resource identifiers/docids).

Alternatively, the model prediction include one or more beam search results generated by performance of a sequential beam search. In computer science, beam search is a heuristic search algorithm that explores a graph by expanding the most promising node in a limited set. Beam search is an optimization of best-first search that reduces its memory requirements. In a beam search, instead of picking the single output (word) as the output, multiple highly probable choices can be retained, e.g., structured as a tree (e.g., using a Softmax on the set of attention scores).

### Example Devices and Systems

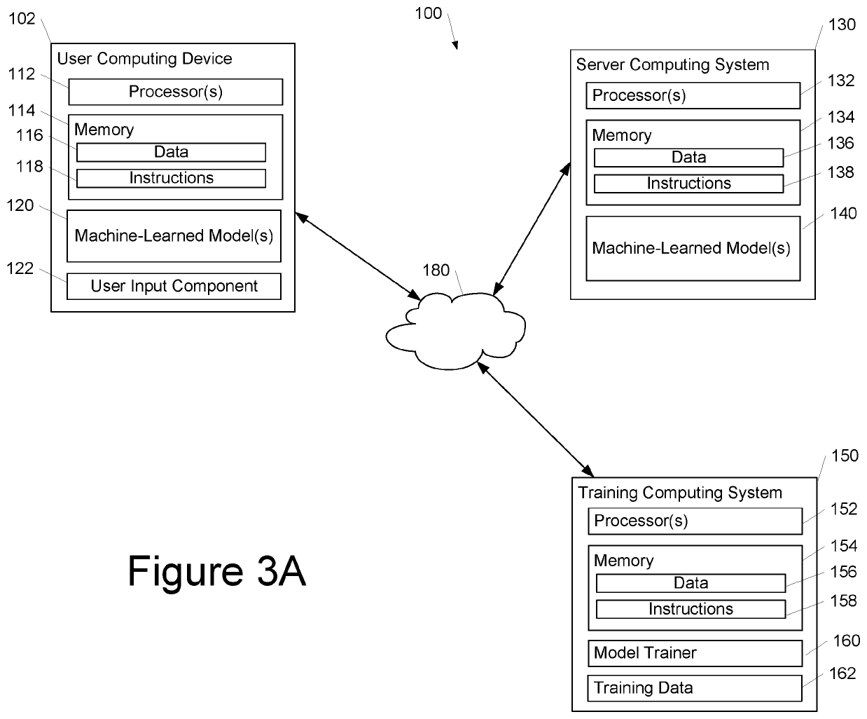

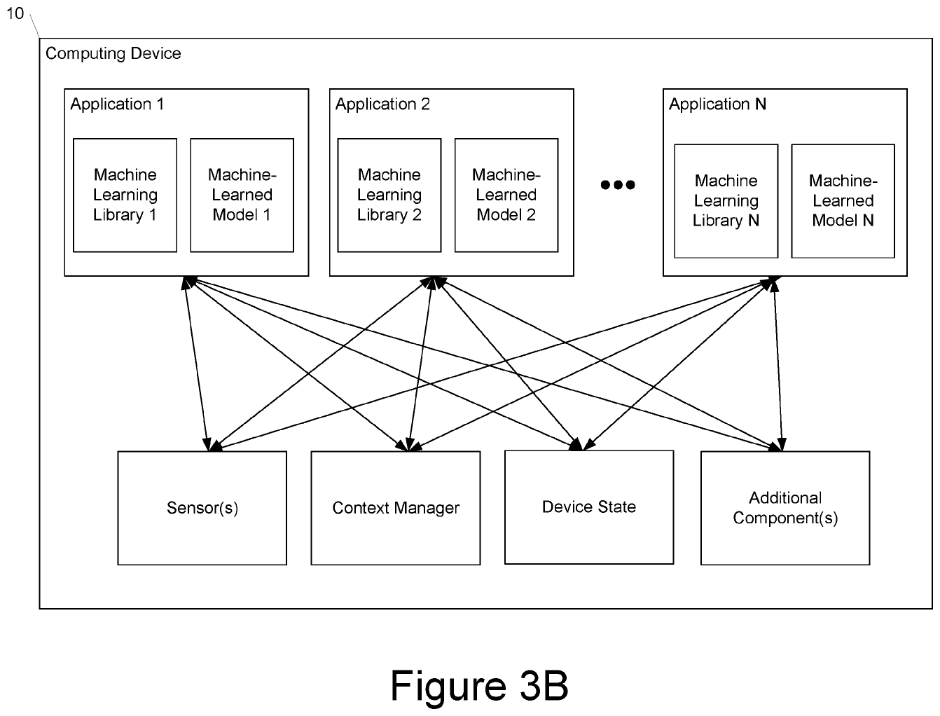

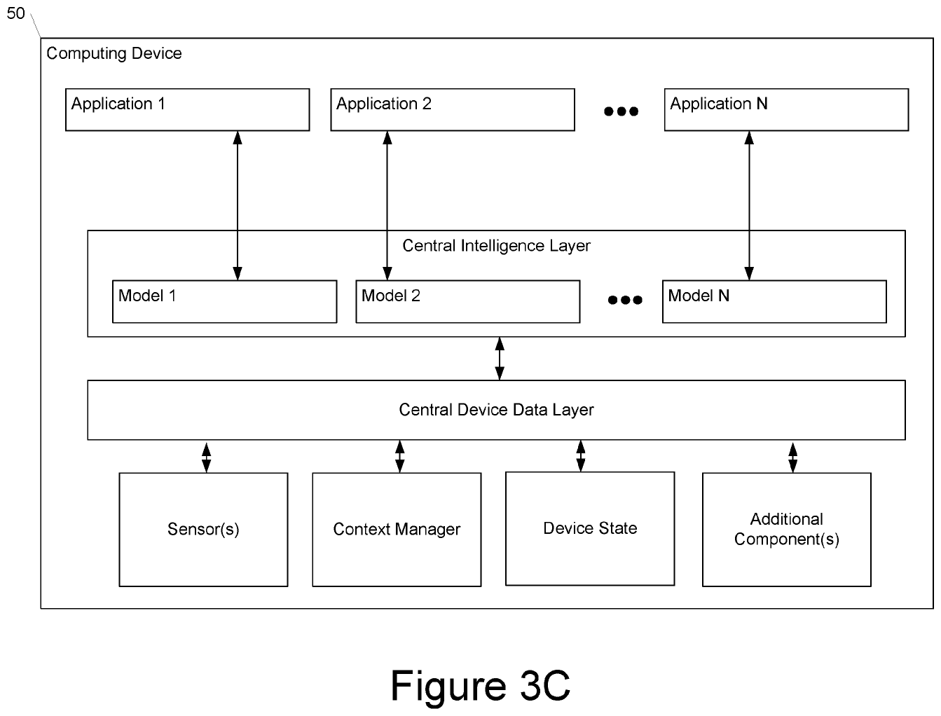

FIG. 3A depicts a block diagram of an example computing system 100 that performs resource retrieval according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1A, 1B, and 2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel resource retrieval across multiple instances of queries).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an information retrieval service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed-forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1A, 1B, and 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a value of a loss function can be backpropagated through the model(s) to update one or more parameters of the model(s) (e.g., based on a gradient of the loss function). Various loss functions can be used such as mean squared error, likelihood loss, cross-entropy loss, hinge loss, and/or various other loss functions. In some implementations, the loss function can be a token-wise negative log probability loss. In some implementations, the loss function can be a learning-to-rank loss, such as a pointwise or listwise ranking loss. Gradient descent techniques can be used to iteratively update the parameters over a number of training iterations. The functions and techniques described above can be applied at the indexing training phase and/or the retrieval training phase.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, a resource corpus and/or query/resource tuples where each query/resource tuple includes a query and one or more resources that have been labeled as responsive to the query.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to perform resource retrieval with improved computational efficiency, the method comprising:
obtaining, by a computing system comprising one or more computing devices, a query;
processing, by the computing system, the query with a machine-learned resource retrieval model to generate a model prediction from the machine-learned resource retrieval model,
wherein the model prediction directly predicts one or more resources that are predicted to be responsive to the query from a resource corpus containing a plurality of resources,
wherein a plurality of resource identifiers are respectively associated with the plurality of resources, and
wherein the model prediction comprises the resource identifiers for the one or more resources that are predicted to be responsive to the query;
providing, by the computing system, the model prediction as an output.

2. The computer-implemented method of claim 1, wherein:
the machine-learned resource retrieval model comprises a sequence-to-sequence model that receives and processes the query as an input sequence to generate one or more predicted output sequences as the model prediction; and
the one or more predicted output sequences correspond to the resource identifiers of the one or more resources that are predicted to be responsive to the query.

3. The computer-implemented method of claim 1, wherein the respective resource identifier associated with each resource in the plurality of resources comprises an unstructured atomic identifier.

4. The computer-implemented method of claim 1, wherein the respective resource identifier associated with each resource in the plurality of resources comprises an unstructured string identifier.

5. The computer-implemented method of claim 1, wherein the respective resource identifier associated with each resource in the plurality of resources comprises a structured semantic identifier.

6. The computer-implemented method of claim 5, wherein the respective structured semantic identifier associated with each resource in the plurality of resources has been generated via iterative clustering of a plurality of embeddings respectively associated with the plurality of resources.

7. The computer-implemented method of claim 1, wherein the machine-learned resource retrieval model has been trained using an indexing loss function, wherein the indexing loss function evaluates an ability of the machine-learned resource retrieval model to output the resource identifier associated with a particular resource when provided with data descriptive of the particular resource as an input.

8. The computer-implemented method of claim 7, wherein the data descriptive of the particular resource comprises:
direct indexing tokens extracted from the particular resource;
set indexing tokens extracted from the particular resource; or
inverted indexing tokens extracted from the particular resource.

9. The computer-implemented method of claim 1, wherein the machine-learned resource retrieval model has been trained using a retrieval loss function, wherein the retrieval loss function evaluates an ability of the machine-learned resource retrieval model to output the resource identifier associated with a particular resource when provided with a training query for which the particular resource has been labeled as a response.

10. The computer-implemented method of claim 1, wherein the machine-learned resource retrieval model has been trained using an indexing loss function and a retrieval loss function in a multi-task training approach.

11. The computer-implemented method of claim 1, wherein the model prediction from the machine-learned resource retrieval model comprises a softmax output over the plurality of resources.

12. The computer-implemented method of claim 1, wherein the model prediction from the machine-learned resource retrieval model comprises one or more beam search results generated by performance of a sequential beam search.

13. A computing system for training a model to perform resource retrieval with improved computational efficiency, the computing system comprising:
one or more processors; and
one or more non-transitory computer-readable media that collectively store instructions that, when executed by the one or more processors, cause the computing system to perform operations, the operations comprising:
obtaining, by the computing system, a resource corpus comprising a plurality of resources, wherein a respective resource identifier is associated with each of the plurality of resources; and
for each of one or more input resources of the plurality of resources:
processing, by the computing system, data descriptive of the input resource with a resource retrieval model to generate a predicted resource identifier for the input resource;
evaluating an indexing loss function that compares the predicted resource identifier to the actual resource identifier for the input resource; and
modifying one or more parameters of the resource retrieval model based on the indexing loss function.

14. The computing system of claim 13, wherein the data descriptive of the input resource comprises:
direct indexing tokens extracted from the input resource;
set indexing tokens extracted from the input resource; or
inverted indexing tokens extracted from the input resource.

15. The computing system of claim 13, wherein the respective resource identifier associated with each resource in the plurality of resources comprises a structured semantic identifier.

16. The computing system of claim 15, wherein the respective structured semantic identifier associated with each resource in the plurality of resources has been generated via iterative clustering of a plurality of embeddings respectively associated with the plurality of resources.

17. The computing system of claim 13, wherein the operations further comprise:
training the resource retrieval model using a retrieval loss function, wherein the retrieval loss function evaluates an ability of the resource retrieval model to output the resource identifier associated with a particular resource when provided with a training query for which the particular resource has been labeled as a response.

18. The computing system of claim 17, wherein the operations comprise training the resource retrieval model using the indexing loss function and the retrieval loss function in a multi-task training approach.

19. The computing system of claim 13, wherein the model prediction from the resource retrieval model comprises a softmax output over the plurality of resources.

20. The computing system of claim 13, wherein the model prediction from the resource retrieval model comprises one or more beam search results generated by performance of a sequential beam search.
